(19) United States
(12) Patent Application Publication
(10) Pub. No.: US 2005/0223094 A1
(43) Pub. Date: Oct. 6, 2005

(54) Data exchange system with conditional access on a data transfer network

(76) Inventor: Bertrand Bouvet, Perros-Guirec (FR)

Correspondence Address: YOUNG & THOMPSON, 745 SOUTH 23RD STREET, 2ND FLOOR, ARLINGTON, VA, 22202, US

(21) Appl. No.: 10/510,449

(22) PCT Filed: Apr. 4, 2003
(86) PCT No.: PCT/FR03/01081

§ 371 Date: Apr. 5, 2005

(30) Foreign Application Priority Data
Apr. 8, 2002 (FR) 02/04361

(51) Int. Cl. G06F 15/173

(52) U.S. Cl. 709/225; 709/224

(57) ABSTRACT

A data exchange system on a data transfer network (2) between a receiver station (6) and a data (I*) server (4) with conditional access, wherein data exchanges over the network (2) are managed and authorized by a control server (20). The control server (20) is associated with: automatic elements (7, 22, 24) forming a catalogue of useable access instruments, accessible to a user of the receiver station (6) for selection, by the user, of one of the access instruments; automatic elements (26) for determining corresponding control parameters of data exchange control over the network (2); and automatic elements (28) for controlling data exchanges over the network (2) based on the thus determined parameters.

The present invention relates to a system of data exchange between a receiver station and a data server with conditional access through access instruments.

Such systems are already known in the state of the art, in which data exchanges over a data transfer network such as for example the Internet network are managed by a control server, in order to allow access to data with access conditional upon the access instruments used.

However, these systems can be operated by a restricted number of users.

Specifically, certain data exchange systems require the presence, on the receiver station, of previously downloaded specific software means that execute a new connection dedicated to that exchange in order to allow access to data after verification of a credit and/or of billing data with the telephone operator handling the connection.

Due to the use of a connection dedicated to this data exchange, these systems are not very user friendly and are suitable only for a specific use with the single telephone operator which is handling the connection. Thus, users that are not registered with this operator do not have access to these data.

In particular, these systems do not allow data exchanges with users situated outside the geographic coverage zone of that operator.

In other systems, the data exchange is carried out without a new connection, on verification of the access instruments associated with a usage credit and/or with billing data with the Internet network access provider.

A user is then directly charged with the cost of the data exchanges on his account managed by the Internet network access provider and, as before, only users registered with that access provider can access this data.

The aim of the invention is to solve these problems by allowing access to conditional access data for an increased number of users.

The subject of the present invention is a data exchange system over a data transfer network between a receiver station and a data server with conditional access, in which the data exchanges over the network are managed and authorized by a control server, characterized in that said control server is associated with:
automatic means forming a catalog of usable access instruments accessible by a user of said receiver station for the selection, by this user, of one of these access instruments;
automatic means for determining corresponding parameters for control of the data exchanges over said network; and
automatic means of data exchange control over this network according to the parameters thus determined.

According to other features:
said means forming a catalog of usable access instruments comprise:
   storage means comprising a predetermined list of access instruments authorized for access to said conditional access data;
   data acquisition means relating to the constitution and operation of the system and of the elements composing it; and
   means of establishment of the catalog of usable access instruments from at least said list of authorized instruments and of said acquired data relating to the system;
said acquisition means comprise means of analysis of the receiver station, suitable for delivering:
   data relating to the nature of the receiver station; and/or
   data relating to the exchange capabilities of the receiver station;
said acquisition means comprise means of connection between the receiver station and the network, suitable for delivering:
   data relating to the means of connection between the receiver station and the network; and/or
   data relating to the time of the exchanges;
said control server is associated with means of remote interrogation of said connection means to obtain said data;
said means of determining the exchange control parameters are connected to means of storing data concerning conditions of access to said data with conditional access and to means of storing exchange authorization data associated with the selected access instrument to establish said exchange control parameters;
said means of determination of the exchange control parameters are also connected to means of supervision of the operation of the receiver station, in order to receive, from said means, data relating to the state of activity and/or to the operation of said receiver station;
said means of supervision are formed by software means initially stored in the system and transmitted to said receiver station on which they reside throughout the data exchanges;
said exchange authorization data associated with the selected access instrument correspond to one of the elements in the group consisting:
   of temporal credit data;
   of monetary credit data;
   of fixed charge credit data;
   of data volume credit data; and
   of billing data;
it comprises a user management server comprising at least one database containing said exchange authorization data associated with the access instruments;
said user management server is a server of a provider of access to said data transfer network connecting said receiver station to said network;
said user management server is a server controlling the physical means of connection of the receiver station to the data transfer network;
it comprises means of determining a user identifier associated with said access instruments in order to allow the identification by said user management server of a corresponding user account;
said means of determining a user identifier are automatic means of identification of the receiver station;
said means of determining a user identifier are means of manually inputting of an identifier;
it comprises means of debiting said exchange authorization data, associated, thanks to said user identifiers, with said used access instrument, in order to debit these data according to the data exchanges;
said debiting means comprise a telephone debiting server connected to another network of the telephone type, said server being accessible by said control server, through a programmable call controller and the user management server;
said data exchange control means are suitable for being interposed between said data server and said receiver station in order directly to control all the data exchanges between them and;
said data exchange control means are interrogated periodically by said receiver station in order to transmit to it or not an authorization for access to the data of said data server.

The invention will be better understood on reading the description that follows, given only as an example and made with reference to the appended drawings, in which:

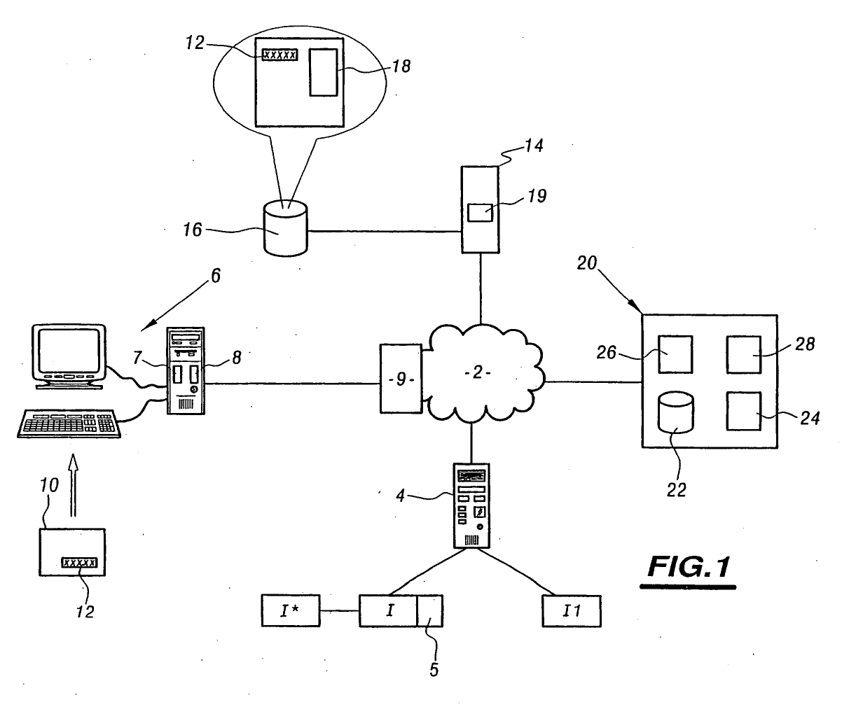

FIG. 1 represents a diagram illustrating the general architecture of a data exchange system according to the invention;

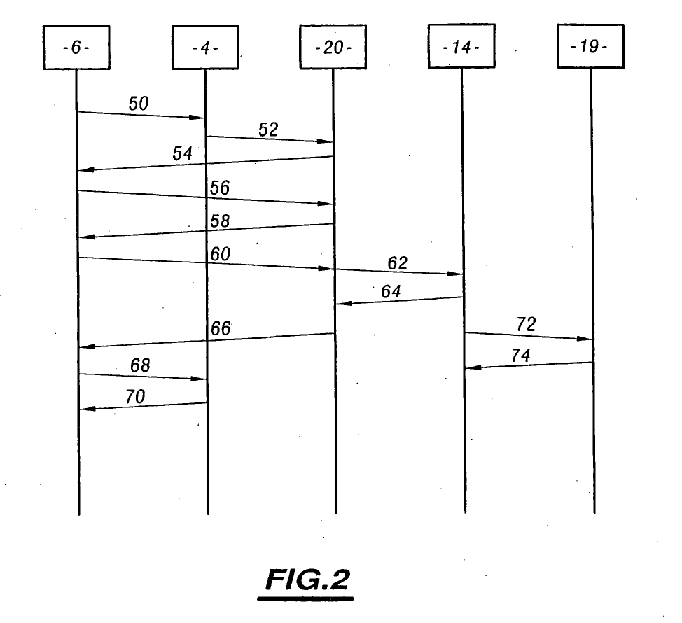

FIG. 2 represents a general block diagram of the operation of the data exchange system as described with reference to FIG. 1;

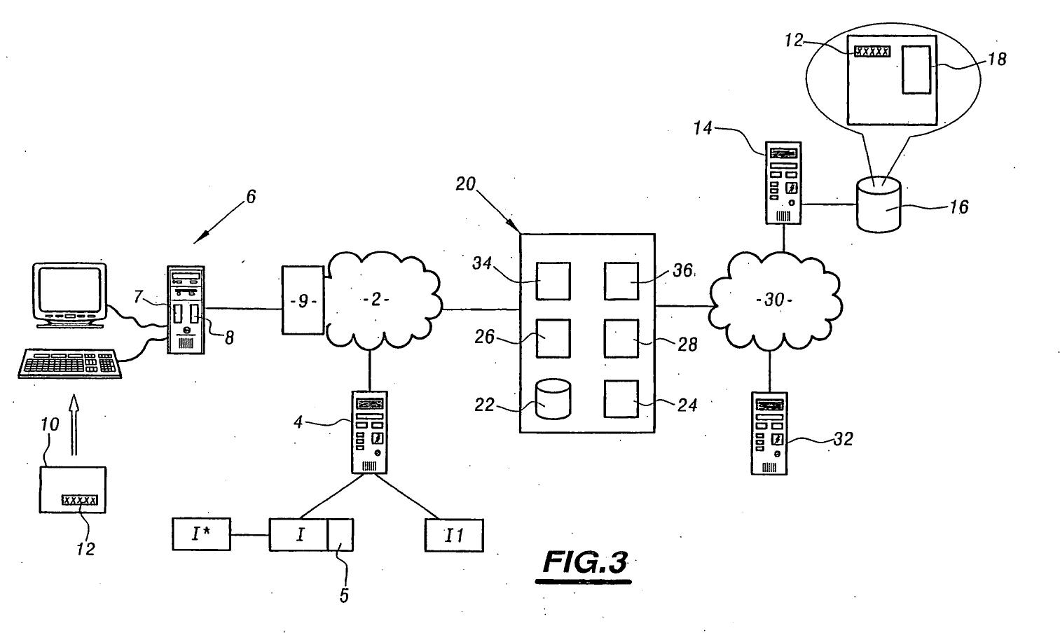

FIG. 3 represents a diagram illustrating the architecture of a particular embodiment of a data exchange system according to the invention; and

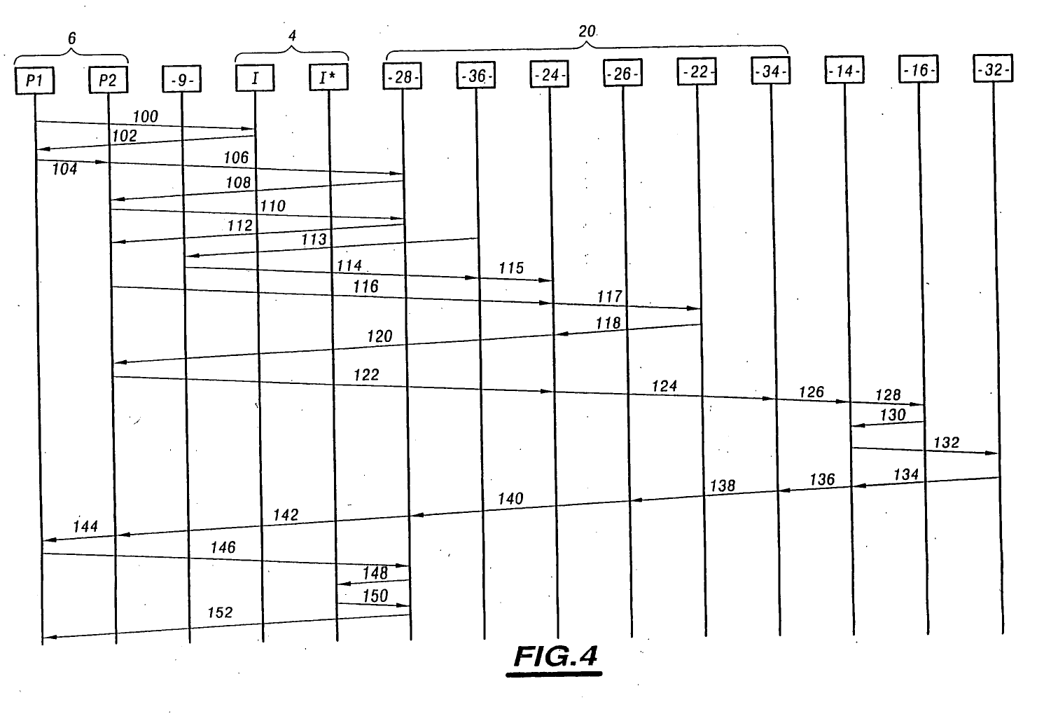

FIG. 4 represents a block diagram of the operation of the data exchange system as described with reference to FIG. 3.

FIG. 1 represents the general architecture of a data exchange system according to the invention.

This system comprises a data transfer network 2 such as the Internet network, to which is connected a data server 4 containing data to be consulted including conditional access data.

These data to be consulted is organized in a tree manner, such that there is a first free access page I, serving as the page for entering a conditional access data zone designated by the general reference I*.

The data server 4 may also contain a set of other free access data, designated by the general reference I1.

In the context of the invention, the entry page I comprises alert means 5 in order to trigger an alert when a request for access to the data I* is received. These means will be described in greater detail below.

The server 4 can be accessed via the network 2 from a receiver station 6, such as for example a microcomputer or any other terminal suitable for the exchange and transfer of data over the network 2.

Conventionally, the receiver station 6 comprises means of exchanging data over the network 2, such as navigation software (not shown) and means 7 of analyzing its constitution.

For example, these means 7 are suitable for determining the nature of the software navigation means and the exchange capabilities of the station 6.

As will be described in greater detail below, the receiver station 6 also comprises means 8 of supervising its state of operation.

The receiver station 6 is associated in a conventional manner with means 9 of connection to the network 2, said means 9 are advantageously suitable for delivering automatically or on request data identifying the physical means of connection used such as a connection of the modem, PSTN, ISDN, ADSL, cable, LAN type or any other connection suitable for transmitting and receiving data over the Internet network 2.

For example, these connection means 9 comprise a telephone switch suitable for storing the telephone number of the telephone line supporting the connection of the receiver station 6 to the network 2.

The means of analysis 7 and of connection 9 therefore form means of acquiring data relating to the constitution and operation of the system.

Furthermore, the user of the receiver station 6 has an access instrument 10 comprising a user identifier 12. This access instrument 10 is managed in a conventional manner by a user management server 14 also connected to the network 2.

The system comprises one or more other user management servers (not shown), similar to the server 14 and allowing each one to manage different access instruments.

For example, these servers are prepay or postpay card management servers or yet billing servers.

The server 14 is connected to a user database 16 which is used to associate with user identifiers such as the identifier 12, data 18 for authorizing exchange over the network, such as for example time credit data such as an authorized connection time, monetary credit data, fixed charge credit data such as consultation tokens, accessible data volume credit data, or yet billing data.

The user management server 14 is also connected to means 19 of debiting exchange authorization data 18 according to the exchanges performed.

According to the invention, the system finally comprises an exchange control server 20 used to manage the data exchanges over the network 2 between the receiver station 6 and the conditional access data access server 4.

This server 20 comprises automatic means forming a catalog of usable access instruments which comprise a database 22 used to associate access conditions data with the data I* of the server 4.

These access conditions data comprise in particular a predetermined list of authorized access instruments and user conditions such as debit and cost conditions.

The server 20 also comprises means 24 of establishing a catalog of access instruments, which use in particular data contained in the database 22 and advantageously data delivered by the means 7 of analyzing the constitution of the receiver station 6 and data delivered by the connection means 9.

The means 24 thus establish a catalog of usable access instruments from this list and these data.

It is therefore appropriate to differentiate the list of authorized access instruments, stored in the database 22 and defined by the owner of the server 4 and the catalog of usable access instruments defined by the means forming the catalog and corresponding to the access instruments of the list of authorized access instruments that are compatible with the system and in particular with the constitution of the receiver station 6.

However, when the system does not have means of analyzing the constitution of the receiver station 6, such as the means 7, and the connection means 9 do not deliver data relating to the physical means of connection used, the catalog of usable access instruments corresponds to the list of authorized access instruments as stored.

In addition, the server 20 comprises automatic means 26 of determining exchange control parameters according to the selected access instrument and according to the corresponding exchange authorization data 18 contained in the user database 16 of the user management server 14.

Advantageously, the means 26 of determining the exchange control parameters also take account of the data delivered by the supervision means 8 of the receiver station 6.

Likewise, the means 26 may take account of the access conditions data associated with the data I* and stored in the database 22 of the control server 20.

For example, the means 26 determine a maximum time for access to the data I* based on access cost data stored in the database 22 and monetary type exchange authorization data 18 stored in the database 16 of the user management server 14.

This maximum access time then constitutes the exchange control parameters.

The means 26 of determining parameters transmit these parameters to automatic data exchange control means 28, in order to allow them to control the data exchanges between the receiver station 6 and the data server 4 according to these parameters.

For example, these data exchange control means 28 comprise a dynamic server capable of formatting an item of data from another server according to operating parameters and various means of physical communication, such as Ethernet communication interface modules.

With reference to FIG. 2, a general summary of the operation of such a system will now be described.

The operation of this system comprises a preliminary configuration step carried out in a conventional manner, during which a certain number of data relating to the server 4 are entered into the database 22 of the server 20.

In particular, these data include the address of the page I for entry into the conditional access zone, and advantageously for added security, the addresses of each of the data pages constituting the conditional access data zone referenced I*.

These data previously stored in the database 22 also comprise a list of authorized access instruments for access to the data I*, and conditions of access to these data I*, such as the cost of access, the authorized access times, the possible debit methods, debit per time spent, per action, per subscription, etc.

During this preliminary step, the owner of the server 4 is required to create, on the page I for entry into the conditional access data zone, the alert means 5 used to alert the server 20 when there is a request for access to the data I*.

For example, these alert means 5 consist of an executable software code for redirection of the access requests to the control server 20.

Thus, during a step 50, a request from the receiver station 6 is addressed to the data server 4 for access to the conditional access data I* and the alert means 5 then alert the control server 20 during a step 52.

During a step 54, the server 20 returns the means of analysis 7 and of supervision 8 to the receiver station 6 in the form for example of software means transferred to and executed on this receiver station 6.

The analysis means 7 deliver to the exchange control server 20 and, in a step 56, data relating to the constitution of the receiver station 6, such as, for example, its nature and/or its exchange capabilities such as the version of the navigation software means used.

Furthermore, the connection means 9 deliver to the control server 20 data relating for example to the nature and time of the connection; such data are interpreted by the means forming the catalog.

Thus, the server 20 automatically determines a catalog of usable access instruments according to the list of authorized access instruments, stored in the database 22 and, advantageously, according to the data transmitted by the analysis means 7 and the connection means 9.

This catalog of usable access instruments therefore corresponds to the authorized access instruments compatible with the system and in particular with the constitution of the receiver station 6 and with the connection between the latter and the network 2.

For example, when the receiver station 6 is connected to the network 2, via an international link or a LAN link, the absence of a telephone line number in the data delivered by the connection means 9 makes a direct charge on a bill to a telephone operator impossible.

The catalog of usable access instruments thus determined is then transmitted, during a step 58, by the server 20 to the receiver station 6 so that its user can select one of these access instruments.

This selection is returned, during a step 60, by the receiver station 6 to the exchange control server 20 with an identifier of the selected access instrument. For example, the identifier number 12 of the access instrument 10 is returned.

The server 20 then interrogates the user management server 14, during a step 62, and retrieves, during a step 64, the exchange authorization data 18 associated with the selected access instrument 10.

According to these data, the means 26 of determining parameters automatically determine exchange control parameters, such as a maximum access time, a volume of data, a number of authorized actions, etc.

In particular, when the exchange authorization data are billing data, these parameters may be an authorization for unlimited access or a maximum limit equivalent to an authorized overdraft.

These parameters are used by the server 20 to send to the receiver station 6, during a step 66, an authorization to access the data I* of the server 4.

Thus, within the limit of this access authorization determined according to the exchange authorization data 18 associated with the access instrument 10 used, the exchange control server 20 allows access to the data I* by the receiver station 6 during steps 68 and 70.

In parallel to these data exchanges and under the control of the server 20, the user management server 14 gains access to the means 19 of debiting the exchange authorization data 18 in order to debit them from the cost of these exchanges.

Advantageously, the supervision means 8 are used to ensure the operation of the receiver station 6 in order, for example, to interrupt the debiting in the event of this station 6 malfunctioning or yet to determine the number of consultation windows in progress and to adjust the debiting accordingly.

It is apparent therefore that the system described can be used to manage a plurality of different access instruments thus allowing access, in a user-friendly manner and without disconnection of the link, to conditional access data for a greater number of users.

FIG. 3 shows the architecture of a particular embodiment of a system according to the invention.

In this figure, identical reference numbers have been used to identify elements identical or similar to those shown in FIG. 1.

In this embodiment, the user management server 14 can be accessed, via the control server 20, through a second data transfer network 30 such as the PSTN telephone network.

For example, this server 14 is a postpaid card management server like those known in the state of the art and the exchange authorization data 18 contained in the database 16 then correspond to billing data.

In this embodiment, the means 19 of debiting the exchange authorization data comprise a telephone debiting server 32 such as a server of the “AUDIOTEL” or “TELETEL” type.

As a result, the exchange control server 20 comprises a programmable call controller 34 suitable for transmitting calls over the PSTN network 30 in order to allow the server 20 to establish links and exchange data over that network 30, in particular with the user management server 14 and the debiting server 32.

In addition, the server 20 comprises means 36 of interrogating the connection means 9 in order to obtain from the latter data relating to the connection between the receiver station 6 and the network 2.

Finally, in this exemplary embodiment, the means 28 of controlling the data exchanges over the network 2 comprise a data transfer module of the “PROXY” type via which the data travel between the server 4 and the receiver station 6.

So that the data travel via the control means 28, all the pages of data I* have been modified and have been associated with the alert means 5, such that they are all redirected and cannot be sent to the receiver station 6 other than via the exchange control means 28.

FIG. 4 shows a block diagram of the operation of the system described with reference to FIG. 3.

On the receiver station 6 and in a conventional manner, a user activates a consultation window P1. During a step 100, the window P1 addresses a request for access to the conditional access data I* of the server 4 and receives in return, during a step 102, the data page I for entry into the conditional access data zone; said page I comprises the alert means 5.

For example, this page describes the conditions and cost of access to the conditional access data I*.

A confirmation button on the page P1 allows the user of the receiver station 6 to accept the conditions of the data exchanges.

During a step 104, this confirmation gives rise to the creation of a management window P2.

The window P2 having been created by the window P1, a relation exists between these two windows, such that data exchanges are possible between them.

In addition, this confirmation, due to the presence in the page I of the alert means 5, generates the alert of the control server 20.

This alert contains the identification of the conditional access data pages I* of the server 4 which the user of the receiver station 6 wishes to consult.

This alert is transmitted during a step 106, via the window P2 to the data exchange control means 28 of the control server 20 which return connection instructions to the management window P2, during a step 108.

In response, the management window P2 makes a request to the server 20, during a step 110, in order to receive, during a step 112, the means 8 of supervision of the operation of the receiver station 6.

These means 8 appear, for example, in the form of “JAVASCRIPT” code used to collect data on the operation of the receiver station 6 and are, for example, included in the management window P2.

Advantageously, these supervision means 8 are specific to the server 4 for reasons of security.

In parallel, and during a step 113, the interrogation means 36 interrogate the connection means 9 in order to receive, during a step 114, data relating to the nature and capabilities of the connection between the receiver station 6 and the network 2.

These data comprise, for example, the number of the calling telephone line and the time of the call and are transmitted to the means 24 of establishing a catalog of usable access instrument during a step 115.

Similarly, during a step 116, the analysis means 7 transmit, to these means 24 of establishing a catalog, data relating to the constitution of the receiver station 6.

During steps 117 and 118, the means 24 of establishing a catalog of usable access instruments interrogate the database 22 in order to extract therefrom the data linked to the data server 4 and in particular the list of authorized access instruments for accessing the data I* as previously defined by the owner of the server 4.

With the aid of these data and of the data transmitted by the analysis means 7 and the interrogation means 36, the means 24 automatically establish a catalog of usable access instruments.

Thus, during a step 120, the means 24 return to the management window P2 a catalog of usable access instruments.

In the example described, this catalog comprises the use of postpaid cards, such as the cards managed by the server 14, granting a time credit, a monetary credit or a fixed charge credit to a given user.

Thereafter, the user of the receiver station 6 confirms one of these options and in response transmits, during a step 122, his choice concerning the access instrument to be used.

In the example described, this user chooses the postpaid method using the user card 10.

Thus, during the step 122, the user transmits identification data concerning himself and in particular the user number 12 which contains the references of the user management server 14.

This data is transmitted, during a step 124, to the programmable call controller 34 which calls and interrogates the user management server 14 during a step 126.

The references of the user management server 14 are contained in the database 22 and the programmable call controller 34 interrogates the latter in order to extract them and execute the step 126.

Thereafter, the server 14 interrogates the database 16 and, after the steps 128 and 130, obtains the exchange authorization data 18 associated with the access instrument 10 thanks to the user number 12.

In the example described, these data include billing and maximum use limits data.

The server 14 then transmits a call, during a step 132, to the debiting server 32 or “AUDIOTEL” server and allows the establishment of a physical link between the programmable call controller 34 and the debiting server 32 which sends, during a step 134, a signal to start billing. The debit may be made in several ways, such as a fixed cost, a cost according to time or yet an exchange authorization dependent on a subscription.

During a step 136, the server 14 returns to the programmable call controller 34 data signaling the beginning of billing and the exchange authorization data associated with the access instrument 10 and data linked to the method of debit.

The exchange authorization data are transmitted to the module 26 for determining the operating parameters during a step 138 which, according to the data received and the data linked to the server 4 contained in the database 22, automatically determine control parameters which they deliver to the exchange control means 28, during a step 140.

For example, these parameters include a maximum usage time obtained thanks to knowing the cost of access to the data I* and the credit allocated to the access instrument 10 or yet these parameters include a maximum volume of data, a number of requests, a consultation time band or any other parameter regulating the data exchanges.

The means 28 then transmit, during a step 142, an access authorization to the management window P2 which transmits it, during a step 144, to the consultation window P1.

Thus, the consultation window P1 makes in a conventional manner a request to consult the data I* which, through the existence of the alert means 5, is addressed directly to the exchange control means 28 during a step 146. The latter, if the access authorization is still valid, retrieve this data on the server 4 during the steps 148 and 150 and send them to the receiver station 6 during a step 152.

Throughout the data exchange between the receiver station 6 and the server 4, the exchange authorization data 18 associated with the access instrument used 10 are debited by the debiting server 32.

According to the exchange parameters, the debit may be made in several ways. For example, if it is a debit as a function of elapsed time, during the exchanges, the communication is maintained between the programmable call controller 34 and the debiting server 32 while being supervised by the server 14.

For billing per action, this communication is maintained only for the time necessary to transfer the data between the programmable call controller 34 and the debiting server 32.

Thus, if the exchange authorization data 18 associated with the access instrument 10 indicate a zero credit, the server 14 disconnects the link between the programmable call controller 34 and the server 32.

As a result, the exchange control means 28 of the server 20 no longer authorize the transfer of data I* thus interrupting the exchanges between the server 4 and the receiver station 6.

Similarly, if the user leaves one tariff zone for another tariff zone, this change is detected by the exchange control means 28, such that the control server 20 repeats a verification and linking cycle with the user management server 14. Thereafter, it breaks off the connection with the debiting server 32 in order to make a new connection with another debiting server similar to the server 32 and then to modify the data exchange control parameters without disconnecting or modifying the connection between the receiver station 6 and the data server 4.

In such a situation, the management window P2 displays a new page describing the new billing conditions.

In the case of a debit by subscription, the user management server 14 returns an exchange authorization directly to the exchange control server 20 without passing via the debiting server 32.

Furthermore, the supervision means 8 constantly scrutinize the state of the receiver station 6 and inform the control server 20 thereof.

Thus, when the consultation window P1 is closed intentionally or unintentionally following a malfunction, the management window P2 is also closed causing the destruction of the supervision means 8. As a result, the exchange control server 20 no longer receives data from the receiver station 6 so it interrupts the current debiting.

The system described can therefore be used to access conditional access data by the use of several types of access instruments in order to allow a consultation of these data, without disconnection, by a large number of users.

In another embodiment, the exchange control means 28 do not manage the data transfers between the server 4 and the receiver station 6. In this case, the supervision means 8 periodically address access authorization renewal requests to the control means 28.

Thus, if the credit linked to the access instrument used 10 has expired, the user management server 14 breaks off the connection between the server 20 and the debiting server 32. The access authorization is then no longer renewed, and this is detected by the supervision means 8 during a later request and causes the closure of the consultation window P1 and the management window P2.

The server 20 may also address instructions to the supervision means 8 in order to cause the closure of the consultation window P1 and the management window P2.

Such an embodiment requires the presence of alert means such as the means 5 only on the entry page I in the conditional access data zone I*, which reduces the modifications to be made to the existing elements and facilitates the use of this system.

Naturally, embodiments other than those described may be envisaged.

The user management server 14 may be of different types such as a server of a provider of access to the network 2.

In this case, the user identifier 12 may comprise authentication data such as a user name and a password stored in a file residing on the station 6 and allowing an automatic identification.

In a similar manner, the user management server 14 may be a telephone operator server, in the case where the link between the receiver station 6 and the Internet network 2 passes through a medium such as a PSTN telephone network or a mobile telephone network.

In yet other embodiments, the user is identified automatically, for example, by the automatic retrieval of the telephone number used for the connection between the receiver station 6 and the Internet network 2 at the connection means 9 and in particular at the switching and access equipment such as equipment units currently called “NAS”, “BAS” or “PAS”.

Such an identification is particularly suitable when the user management server is a server of a telephone operator or of an access provider.

The access instruments then correspond to contracts between the user management server and the users, these contracts being oral and/or written and being associated with exchange authorization data.

For example, they are contracts with the provider of access to the network 2 or with the operator of the physical means of connection of the receiver station 6 to the network 2, which specify a maximum monetary overdraft authorization.

In yet other embodiments, the means 8 of supervision of the receiver station 6 are produced with the aid of executable software means called “appliquettes” or “Javascript” or yet make use of the resident identification files at the receiver station 6 routinely called “cookies”.

Furthermore, these supervision means 8 as well as the means 7 of analyzing data relating to the system may be located on a server of a provider of access, for the receiver station 6, to the network 2 or yet on the control server 20, thus being inaccessible to the user of the station 6 in order to increase the security of the system.

In this case, the acquisition means 7 and supervision means 8 are suitable for remote acquisition of the data relating to the system and comprise for example a so-called dynamic Internet server using “VBSCRIPT” or “PHP” software means.

When these analysis means 7 and supervision means 8 are transferred to the receiver station 6 as was described with reference to FIGS. 3 and 4, they may be located initially on the control server 20 or on another server connected to the network 2 such as the data server 4.

Advantageously, the exchange control server 20 comprises additional elements such as means of using a remote database, real time billing means or yet means of statistical traffic analysis.

The elements of the control server 20 may be arranged differently in the equipment units of the system and in particular they may all be contained in the data server 4.

Naturally, the control server 20 may reference a plurality of conditional access data servers such as the data server 4, and is connected to a plurality of user management servers such as the server 14.

It is therefore apparent that the system of the invention allows an exchange of data between a receiver station and a conditional access data server allowing the use of different types of access instruments while allowing an interruption-free connection and a precise and modifiable debit while connected.

Thus, the diversity of types of usable access instruments can be used to find alternatives when a connection is made from a geographically remote server preventing automatic recognition or billing with a telephone operator, or yet can be used to dispense with the restriction to specific connection means such as a PSTN telephone link while requiring only little or no modification of the existing elements.

The system of the invention therefore allows access to conditional access data in a continuous and user-friendly manner to a greater number of users.

1. A data exchange system over a data transfer network (2) between a receiver station (6) and a data (I*) server (4) with conditional access, in which the data exchanges over the network (2) are managed and authorized by a control server (20), characterized in that said control server (20) is associated with:
automatic means (7, 22, 24) forming a catalog of usable access instruments accessible by a user of said receiver station (6) for the selection, by this user, of one of these access instruments;
automatic means (26) for determining corresponding parameters for control of the data exchanges over said network (2); and
automatic means (28) of data exchange control over this network (2) according to the parameters thus determined.

2. The system as claimed in claim 1, characterized in that said means forming a catalog of usable access instruments comprise:
storage means (22) comprising a predetermined list of access instruments (10) authorized for access to said conditional access data (I*);
data acquisition means (7, 9) relating to the constitution and operation of the system and of the elements composing it; and
means (24) of establishment of the catalog of usable access instruments from at least said list of authorized instruments and of said acquired data relating to the system.

3. The system as claimed in claim 2, characterized in that said acquisition means comprise means of analysis (7) of the receiver station, suitable for delivering:
data relating to the nature of the receiver station (6); and/or
data relating to the exchange capabilities of the receiver station (6).

4. The system as claimed in claim 2, characterized in that said acquisition means comprise means of connection (9) between the receiver station (6) and the network, suitable for delivering:
data relating to the means of connection between the receiver station (6) and the network (2); and/or
data relating to the time of the exchanges.

5. The system as claimed in claim 4, characterized in that said control server (20) is associated with means (36) of remote interrogation of said connection means (9) to obtain said data.

6. The system as claimed in claim 1, characterized in that said means (26) of determining the exchange control parameters are connected to means (22) of storing data concerning conditions of access to said data with conditional access (I*) and to means (16) of storing exchange authorization data (18) associated with the selected access instrument to establish said exchange control parameters.

7. The system as claimed in claim 6, characterized in that said means (26) of determination of the exchange control parameters are also connected to means (8) of supervision of the operation of the receiver station (6), in order to receive, from said means, data relating to the state of activity and/or to the operation of said receiver station (6).

8. The system as claimed in claim 7, characterized in that said means (8) of supervision are formed by software means initially stored in the system and transmitted to said receiver station (6) on which they reside throughout the data exchanges.

9. The system as claimed in claim 6, characterized in that said exchange authorization data associated with the selected access instrument (10) correspond to one of the elements in the group consisting:
of temporal credit data;
of monetary credit data;
of fixed charge credit data;
of data volume credit data; and
of billing data.

10. The system as claimed in claim 6, characterized in that it comprises a user management server (14) comprising at least one database (16) containing said exchange authorization data associated with the access instruments (10).

11. The system as claimed in claim 10, characterized in that said user management server is a server of a provider of access to said data transfer network (2) connecting said receiver station (6) to said network (2).

12. The system as claimed in claim 10, characterized in that said user management server (14) is a server controlling the physical means of connection of the receiver station (6) to the data transfer network (2).

13. The system as claimed in claim 10, characterized in that it comprises means of determining a user identifier (12) associated with said access instruments (10) in order to allow the identification by said user management server (14) of a corresponding user account.

14. The system as claimed in claim 13, characterized in that said means of determining a user identifier (12) are automatic means of identification of the receiver station (6).

15. The system as claimed in claim 13, characterized in that said means of determining a user identifier (12) are means of manually inputting an identifier.

16. The system as claimed in claim 6, characterized in that it comprises means (19) of debiting said exchange authorization data (18), associated, thanks to said user identifiers (12), with said used access instrument (10), in order to debit these data (18) according to the data exchanges.

17. The system as claimed in claim 16, characterized in that said debiting means comprise a telephone debiting server (32) connected to another network (30) of the telephone type, said server (32) being accessible by said control server (20), through a programmable call controller (34) and the user management server (14).

18. The system as claimed in claim 1, characterized in that said data exchange control means (28) are suitable for being interposed between said data server (4) and said receiver station (6) in order directly to control all the data exchanges between them.

19. The system as claimed in claim 1, characterized in that said data exchange control means (28) are interrogated periodically by said receiver station (6) in order to transmit to it or not an authorization for access to the data of said data server (4).
